(19) United States
(12) Patent Application Publication
(10) Pub. No.: US 2004/0232390 A1
(43) Pub. Date: Nov. 25, 2004

(54) Highly conductive carbon/inherently conductive polymer composites

(76) Inventor: Tito Viswanathan, Little Rock, AR (US)

Correspondence Address: ALAN CHAN, ESQ., 282 FORBELL STREET, BROOKLYN, NY, 11208, US

(21) Appl. No.: 10/819,675

(22) Filed: Apr. 7, 2004

Related U.S. Application Data
(60) Provisional application No. 60/461,156, filed on Apr. 7, 2003.

(51) Int. Cl. H01B 1/00

(52) U.S. Cl. 252/500

(57) ABSTRACT

This invention relates to composites of a highly conductive form of carbon, preferably graphite, and an inherently conducting polymer that exhibits higher conductivity than the conductivities of the individual components and the synthesis of these composites.

### CLAIM OF PRIORITY

This patent application claims priority from provisional patent application Ser. No. 60/461,156, filed on Apr. 7, 2003.

### FIELD OF THE INVENTION

This invention relates to compositions of highly conductive carbon material and inherently conductive polymer composites that possess greater conductivity than the conductivity of the component carbon and polymer materials, and the synthesis thereof. The composite also possesses high dispersibility in a wide variety of solvents.

### BACKGROUND OF THE INVENTION

Carbon black and graphite possess good conductive properties but are highly insoluble in aqueous and organic systems. Composites of carbon black and inherently conductive polymers (ICPs) such as polyaniline (PANi) have been studied but the conductivity of these composites is limited to the conductivity of the PANi. For example, U.S. Pat. No. 5,498,372 to Hedges discloses a carbon allotrope composite formed with an ICP having a highest conductivity of the conducting polymer component (U.S. Pat. No. 5,498,372 (1996) to Hedges). These prior art composites presented an advance over existing technology because the carbon black/ICP composites allowed for easy control of resistivity in the range needed for electrostatic dissipation (ESD). Furthermore, the prior art composites exhibited improved thermal stability over existing technology at the time (see Avlyanov, J., Dahman, S. Chapter 17. Thermally Stable Intrinsically Conductive Polymer-Carbon Black Composites as New Additives for Plastics in Semiconducting Polymers. Eds. Hsieh, Bing R.; Wei, Yen; American Chemical Society, 1999; p. 76). Electrically conducting composites of natural rubber with carbon black and natural rubber with electrically conducting materials polyaniline and polypyrrole have been demonstrated. The composites were processed in a torque rheometer HAAKE and then hot pressed to produce homogeneous and flexible plates. The electrical conductivities were in the order of 10⁻⁷ to 10⁻¹ S/cm, depending on the type of carbon black or conductive compound used and content in the composite. Thermal analysis demonstrated that the compounds are thermally stable up to 300° C. The conductive compounds enhanced the mechanical properties of natural rubber without significant loss of flexibility (Natural rubber composites with conductive compounds based on carbon black and conducting polymers. dos Santos, Marinalva A.; Matloso, Luiz H. C.; Defacio, Regiani; Avlyanov, Jamshid. Dep. Engenharia Materiais, UFSCar, Brazil. Polimeros: Ciencia e Tecnologia (2001), 11(3), 126-134). Very recently, non-aqueous organic secondary battery with conductive polymer-carbon black composite cathode have been demonstrated (Chen, Show-An; Liang, Kai-Min; Yang, Lan-Sheng; Lee, Jen-Jeh (Taiwan). U.S. Pat. Appl. Publ. (2003), 15 pp. CODEN: USXXCO US 2003134196 Al 20030717 Patent written in English. Application: US 2002-264274 20021003. Priority: TW 2001-90124646 20011005. CAN 139:87891 AN 2003:551059 CAPLUS). The non-aqueous secondary organic battery includes an positive electrode of polyaniline-conductive carbon black composite (polyaniline-C composite). The polyaniline-C composite was prepared using a high-speed impingement mill with high-speed fluid striking and grinding functions. The resulting polyaniline-C composite has higher conductivity than the mixture of conductive carbon and polyaniline by direct mixing. The procedure, however, requires a high speed impingement mixer and the conductivity will be limited due to the relatively low conductivity of carbon black. A new design for dry polyaniline rechargeable batteries has been recently Published (A new design for dry polyaniline rechargeable batteries. Karami, Hassan; Mousavi, Mir Fazlollah; Shamsipur, Mojtaba. Chemistry Department, Tarbiat Modarres University (TMU), Tehran, Iran. Journal of Power Sources (2003), 117(1-2), 255-259. CODEN: JPSODZ ISSN: 0378-7753. Journal written in English. CAN 139:199869 AN 2003:340089 CAPLUS).

Polyaniline powder of high conductivity is prepared by chemical polymerization of aniline. The powder is mixed with graphite and acetylene black to obtain the required conductivity. The mixed powder is compressed for use as positive electrodes (cathodes) in batteries. The battery electrolyte comprised of 2 M Zn(ClO₄)₂, 1 M NH₄ClO₄, and 1.0×10⁻⁴ M Triton-X100 at pH 3. Due to the low amount of electrolyte used, the battery was considered as a dry battery.

Highly conductive carbon/ICP composites are desirable for the increased resistivity control and better thermal stability. However, a considerable need exists in the art for an easily dispersible composite that possesses higher conductivity than the conductivity of the component polymer. The composite should be dispersible in a variety of systems both aqueous and organic.

### SUMMARY OF THE INVENTION

The present invention provides a composite of a highly conductive form of carbon (preferably graphite) and an inherently conducting polymer that unexpectedly exhibits higher conductivity than the conductivities of the individual components and the synthesis of these composites. The carbon composite is also dispersible in a wide range of solvents and resins. Specifically, the present invention relates to dispersible composites such as graphite and doped polyaniline; graphite and doped polypyrrole; graphite and doped polythiophene; graphite and doped polyethylenedioxythiophene; and graphite and doped polyphenylenevinylene. In addition, this invention relates to methods of synthesizing these composites by oxidatively polymerizing the corresponding monomers in the presence of dispersed graphite and an acid dopant.

### BRIEF DESCRIPTION OF THE DRAWINGS

The features and advantages of the present invention will become more readily apparent from the following detailed description of the invention in which:

Table 1 shows the varying conductivity of 80/20 (Graphite-Polyaniline) GP composites with various dopants in comparison to conductivity of dedoped 80/20 GP. (Dedoping is accomplished chemically by washing with base followed by extensive water wash in case of GP composites);

FIG. 1 is a graphical depiction of a conductivity study of doped and dedoped graphite/PANi composite (GP composite);

FIG. 2 is a graphical comparison of the surface resistivity of the composite versus percent composite of 80/20 GP and 70/30 GP in a melamine formaldehyde resin (Resimene 735);

FIG. 3 is a graphical depiction of the surface resistivity of an 80/20 GP composite versus % composite in a polyurethane resin (Permax 200, Noveon);

FIG. 4 is a graphical depiction of the surface resistivity of a 70/30 GP composite versus % composite in a polyurethane resin (Permax 200, Noveon);

FIG. 5 is a graphical depiction of the surface resistivity of a 50/50 GP composite versus % composite in a polyurethane resin (Permax 200, Noveon); and

FIG. 6 is a graphical depiction of the surface resistivity of a 20/80 GP composite versus % composite in a polyurethane resin (Permax 200, Noveon).

### DETAILED DESCRIPTION OF THE INVENTION

Carbon black and graphite have wide application in the electronics industry due to their conductive properties, but are highly insoluble in aqueous and most organic solvents. A dispersible carbon black or graphite composite that possesses high conductivity has wide applicability in a variety of fields such as, but not limited to, electrodes, ESD, electromagnetic interference shielding, and primers for plastics coated via electrospray methods. Some carbon black composites formed with inherently conducting polymers (ICPs) are known in the art to address the problem of achieving both conductivity and dispersibility. ICPs are an important class of materials recently recognized by the Nobel Prize in Chemistry in 2000. Many useful ICPs have been developed but few are available commercially (see Shirakawa, Hideki; Louis, Edwin J.; MacDiarmid, Alan G.; Chiang, Chwan K.; Heeger, Alan J. J. Chem. Soc. Chem. Commun., 1977, 578). This limited availability may be due to cost as well as insufficient dispersibility of some ICPs for many applications (see Gregory, Richard V. Chapter 18: Solution Processing of Conductive Polymers: Fibers and Gels from Emeraldine Base Polyaniline in Handbook of Conducting Polymers, Eds. Skotheim, Terje A.; Elsenbaumer, Ronald L.; Reynolds, John R.; Marcel Dekker Inc., 1998; p. 437).

Composites of ICP and carbon black were explored as viable alternatives to the use of polyaniline (PANi) and polypyrrole (PPy) and carbon black (CB) alone as conductive additives in the thermoplastics industry because each of these materials demonstrate undesirable properties at high temperatures (see Avlyanov, J., Dahman, S. Chapter 17. Thermally Stable Intrinsically Conductive Polymer-Carbon Black Composites as New Additives for Plastics in Semiconducting Polymers. Eds. Hsieh, Bing R.; Wei, Yen; American Chemical Society, 1999; p. 76). In particular, each of these materials when used alone as conductive additives displayed poor dispersibility. Resistivity was also difficult to control and conductivity of these materials often degraded when exposed to certain chemicals used in the thermoplastics industry. By stark contrast, when CB and PANi were combined the resultant composite was relatively more dispersible and the resistivity was relatively easy to control. It should be noted that although carbon black and certain ICPs such as PANi are not very dispersible, some increased dispersibility was noted in the prior art composites. This dispersibility, however, is not as high as the dispersibility of the present invention. The conductivity of the prior art CB/PANi composites is below that of CB alone and about the same order of magnitude of PANi (see Hedges, W. L. U.S. Pat. No. 5,498,372 (1996)). The conductivity of these prior art CB/PANi composites varied only slightly with pH (see Avlyanov, J., Dahman, S. Chapter 17. Thermally Stable Intrinsically Conductive Polymer-Carbon Black Composites as New Additives for Plastics in Semiconducting Polymers. Eds. Hsieh, Bing R.; Wei, Yen; American Chemical Society, 1999; p. 76) which indicated that the ICP did not play a significant role in the conductivity. To elaborate, ICPs become insulating when dedoped therefore conductivity should vary in response to pH change. The slight variation of the conductivity of the CB/ICP composite in response to pH change aids in understanding the role of ICP in the overall inventive composites, especially the graphite/ICP composite discussed in detail in Example 2 below. (See Table 1).

Graphite composites have received much less attention than the carbon black composites. Some graphite/PPy composites have been studied for uses in some rechargeable batteries (Veeraraghavan, Basker; Paul, Jason; Haran, Bala; Popov, Branko. Study of polypyrrole graphite composite as anode material for secondary lithium-ion batteries. Journal of Power Sources (2002), 109(2), 377-387. CODEN: JPSODZ ISSN: 0378-7753. CAN 137:219461 AN 2002:432914 CAPLUS), but these studies have been discouraging because these composites possess low conductivities. The aforementioned graphite/PPy study synthesized PPy in the presence of graphite so as to include an electroactive layer in the graphite electrode on the battery. The prior art graphite/PPy composite was non-dispersible and possessed lower conductivity than the composite of the present invention.

The present invention provides a great advance in the art by providing a composite and the synthesis thereof, wherein the composite comprises a highly conductive carbon material and an ICP. The novel advance of the inventive composites arises from the unexpected property of a higher conductivity of the composite than the conductivities of each of the component materials. Another novel unexpected property of the composites of the present invention includes conductivity control of graphite polyaniline composite through pH variation indicative of ICP contribution to conductivity. Furthermore, the inventive composites are dispersible and believed to be thermally stable. Non limiting examples of the ICPs used in the present invention are PANi, Polypyrrole (PPy), polythiophene, polyphenylene vinylene, polyethylenedioxythiophene (PEDOT) as well as substituted ICPs of the aforementioned polymers although it is anticipated other ICPs could be used especially in combination with graphite to yield the desired effects of higher composite conductivity and conductivity variation due to pH change or removal/exchange of dopant or oxidation/reduction. As noted above, it has been unexpectedly found that the graphite-PANi (GP) and graphite-polypyrrole (GPPy) composites possess higher conductivity than the conductivity of the component materials as well as those components known in the prior art. The conductivity values of the inventive GP composites also demonstrated dramatic dependence upon pH variation (ranging from about 0 to 14) changes in contrast to prior art composites. The GP composites possessed higher conductivity values in comparison to the other composites encompassed within the scope of this invention.

To summarize, the present invention provides a great advance in the art by providing synthesis of highly conductive carbon/ICP composites that possess higher conductivity than each of the individual components. The conductivity of these GP composites was highly pH dependent in case of graphite polyaniline composite allowing for control of conductivity in various applications. The following non-limiting examples demonstrate the art of making various carbon/ICP composites where the conductivity is much higher than that of the pure conducting polymer in the composite and higher than the pure allotrope used in making the composite.

Because homogeneity is crucial to the synthesis of consistent composites, the polymerization of the monomer (aniline or pyrrole) in the synthesis of the composite was carried out in the presence of carbon allotropes which were already dispersed in water or otherwise were dispersed in water prior to the polymerization process. Although the aforementioned synthesis was carried out in an aqueous environment, it is believed that the synthesis can also be carried out in the presence of organic dispersions of graphite. The graphite composites demonstrated higher conductivities as well as improved properties over graphite alone for some applications. Furthermore, the use of the graphite as a highly conducting matrix on which to polymerize aniline led to composites with higher conductivities and improved processibility over those known in the art.

The weight percent ratio of graphite to aniline is preferably from about 50:50 to 95:5, although the range may even be varied to 5:95 with results. It is anticipated the ratio of graphite to other ICPs may also fall within this range preferably about 50:50 to 95:5. For instance, the weight ratio of graphite to PPy is also the same. The conductivity values of GP are preferably from about 10 to 400 S/cm. The surface resistivity values of the composites of the present invention are preferably from about 1.00E0 to 1.00E10 ohms/square, and more preferably of from about 1.00E01 to 1.00E07 ohms/square.

The materials obtained for the preparation of the examples discussed immediately below are as follows. Water dispersible colloidal graphite (˜25-28% solids) or solid powdered graphite was used in the preparation of the composites. Aniline, sodium persulfate, methanesulfonic acid (HMSA), p-toluenesulfonic acid (p-TSA), isopropyl phosphate(mono- and di-ester mixture), o-phosphoric acid, sulfuric acid, hydrochloric acid, (±)-10-camphorsulfonic acid (HCSA), 4,5-dihydroxy-2,7-naphthalenedisulfonic acid (4,5-DH-2,7-NSA), and 6,7-dihydroxy-2-naphthalenesulfonic acid (6,7-DH-2-NSA) were obtained from Aldrich Chemical Company.

### EXAMPLE 1

Synthesis of 90/10 GP:

A 36.0 g sample of colloidal graphite (25% solids), 25.0 mL of 1M HMSA, and 1.00 mL aniline were added to a beaker. The solution was cooled to ˜0° C. Then 2.62 g sodium persulfate was added. The reactions were allowed to stir overnight. The solution was then filtered by vacuum through a Whatman #4 filter paper and washed with distilled water. The cake was then washed twice with 50 mL 1M HMSA. The sample was dried under vacuum to determine percent solids of the wet cakes. The conductivity of the pressed pellet was 350 S/cm. The sample was dedoped by stirring the dry solids in 1 M NaOH overnight, vacuum filtering through a Whatman #4 filter paper, and extensively washing with distilled water. The conductivity of the dried dedoped sample was 124 S/cm.

### EXAMPLE 2

Synthesis of 80/20 GP:

A 32.0 g sample of colloidal graphite (25% solids), 50.0 mL of 1M HMSA, and 2.00 mL aniline were added to a beaker. The solution was cooled to ˜0° C. Then 5.24 g g sodium persulfate was added. The reactions were allowed to stir overnight. The solution was then filtered by vacuum through a Whatman #4 filter paper and washed with distilled water. The cake was then washed twice with 50 mL1M HMSA. The sample was dried under vacuum to determine percent solids of the wet cakes. The conductivity of the pressed pellet was 275 S/cm. The sample was dedoped by stirring the dry solids in 1M NaOH overnight, vacuum filtering through a Whatman #4 filter paper, and extensive washing with distilled water. The conductivity of the dried dedoped sample was 92 S/cm.

Surface resistivities

Films of the composites were cast in Resimene 735 (Monsanto), a water-compatible formaldehyde based resin, according to ratios of conductive solids to total solids. The ratio of conductive solids to total solids varied from about 0.1 to 0.9 although this ratio may preferably range from about 1 to 99, more preferably from about 15 to 95 weight percent. Once the resin and sample were mixed, the wet film was applied at a thickness of 15 mils to a glass slide using a draw-down bar. The slides were cured in an oven at 125° C. for approximately 5 minutes. Other surface resistivities were obtained using a similar protocol as aforementioned through using a polyurethane based resin, Permax 200 (Noveon). Wet films were cast at 15 mils onto a glass slide and allowed to cure at room temperature overnight to prevent any cracking in the films.

Both bulk conductivities and film resistivities of the composite samples were determined. DC conductivity measurements were made on pressed pellets with an Alessi four-point conductivity probe connected to a Keithly voltmeter and programmable current source. Surface resistivities were determined by measuring the resistance across the film surface using 1 inch metal clips placed 1 inch apart.

### EXAMPLE 3

Alternate syntheses of 80/20 GP were carried out using several different dopants. The other dopants used were isopropyl phosphate(mono- and di-ester mixture), o-phosphoric acid, sulfuric acid, hydrochloric acid, (±)-10-camphorsulfonic acid (HCSA), 4,5-dihydroxy-2,7-naphthalenedisulfonic acid(4,5-DH-2,7-NSA), and 6,7-dihydroxy-2-naphthalenesulfonic acid(6,7-DH-2-NSA). Each of these dopants was added as a 1 M solution to the reaction vessel and the aforementioned procedure in Example 1 was followed. These samples were dedoped by taking a sample of the dry composite and stirring in 1 M NaOH (pH 12) overnight. Film preparation and determination of bulk conductivity and film resistivity were carried out in substantially the same manner as described in Example 1 above.

Graphite composites exhibited conductivities higher than the other carbon composites discussed herein as well as graphite alone. The synthesis of 80/20 GP composites using a 1M acid solution showed that using HMSA as the dopant gave higher conductivities (σ=275 S/cm) than pTSA (σ=190 S/cm). While not wishing to be bound by theory, prior research with PANi/carbon nanotube composites suggests that an interaction of the quinoid ring of the PANi chain and the nanotube aids in charge transfer (Cochet, Murielle; Maser, Wolfgang K.; Benito, Ana M.; Callejas, M. Alicia; Martinez, M. Teresa; Benoit, Jean-Michel; Schreiber, Joachim; Chauvet, Olivier. Synthesis of a new polyaniline/nanotube composite: “in-situ” polymerisation and charge transfer through site-selective interaction. Chemical Communications (Cambridge, United Kingdom) (2001), (16), 1450-1451. CODEN: CHCOFS ISSN:1359-7345. CAN 135:331940 AN 2001:581362 CAPLUS).

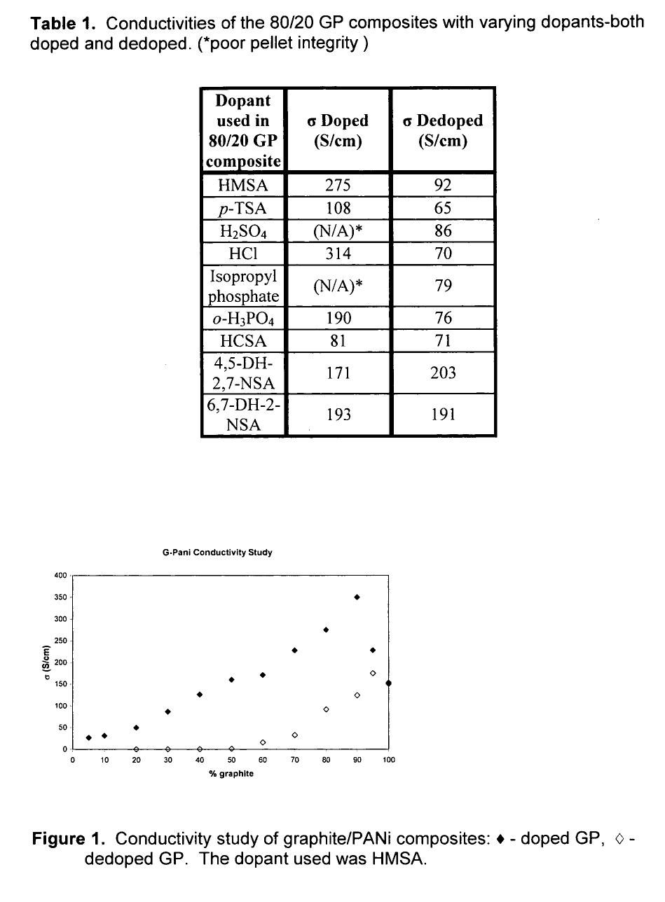

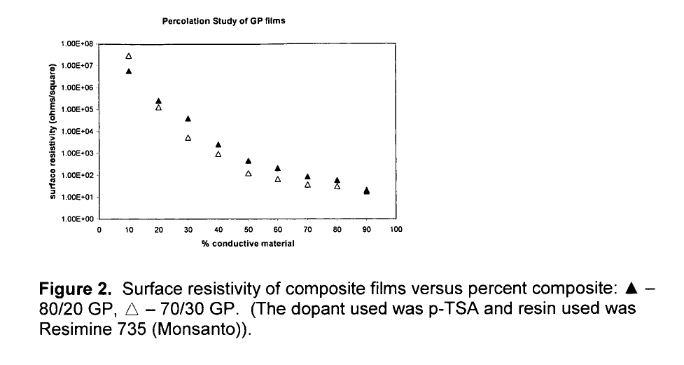

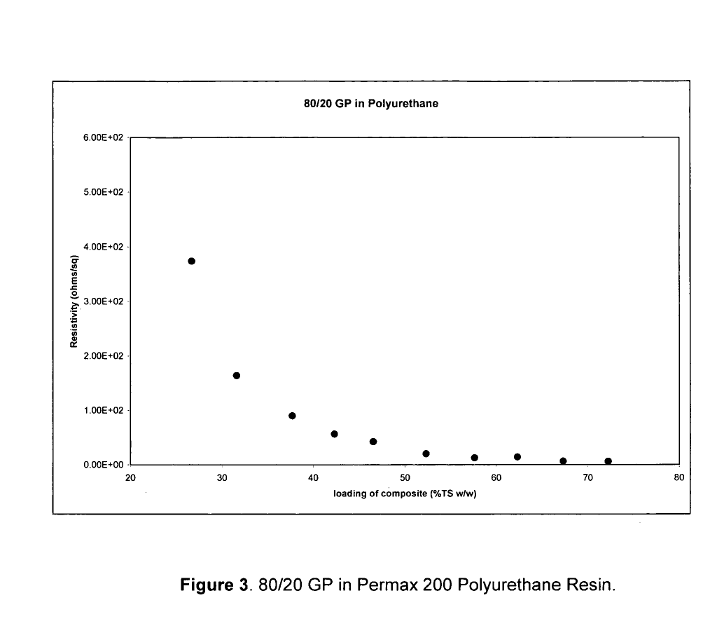

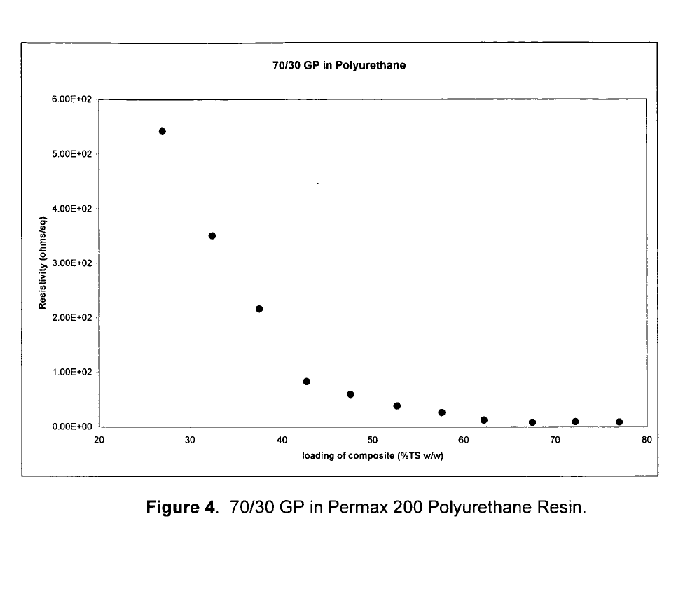

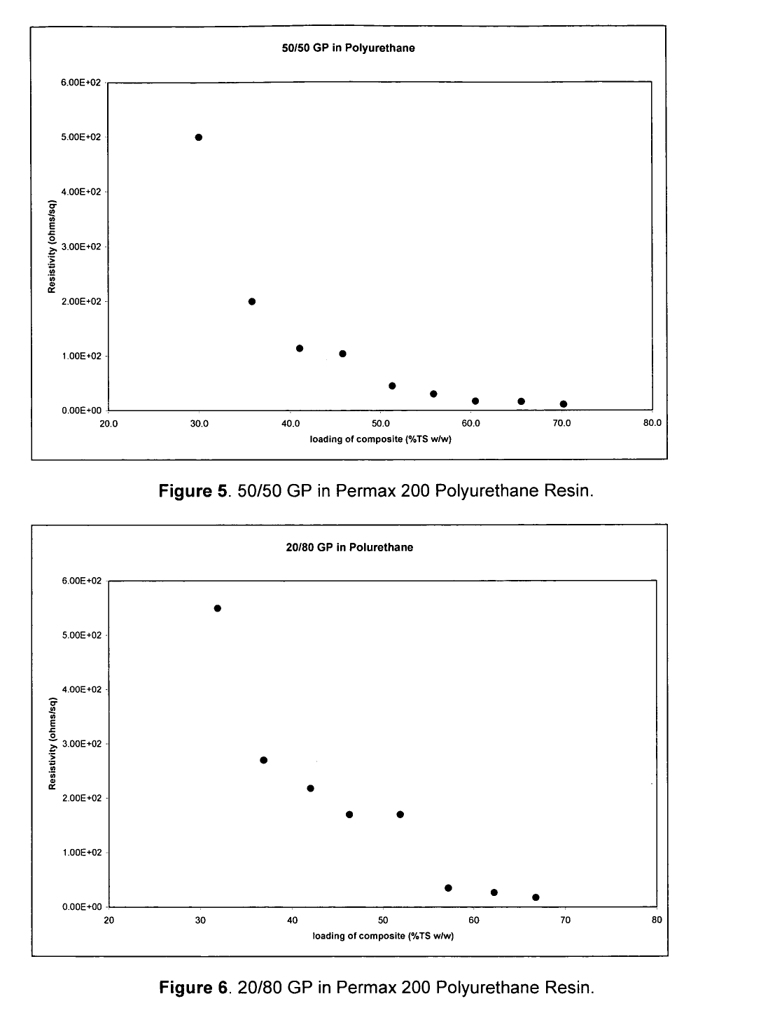

FIGS. 1 and 2 compare the conductivity of composite with respect to varying amounts of graphite for doped and de-doped samples. The highest conductivities measured were 350 S/cm for a 90/10 GP composite and a dramatic decrease in conductivity occurred when the samples were dedoped (FIG. 1). A change of 1 to 2 orders of magnitude is seen in some composites. Clearly, this variation due to pH change is quite different from the previously studied carbon black/ICP composites (see Avlyanov, J., Dahman, S. Chapter 17. Thermally Stable Intrinsically Conductive Polymer-Carbon Black Composites as New Additives for Plastics in Semiconducting Polymers. Eds. Hsieh, Bing R.; Wei, Yen; American Chemical Society, 1999; p. 76). As discussed previously, the prior art carbon black/ICP composite conductivity varied only slightly in response to pH change. This pH (in a range of variation of from about 7 to 14) dependence of the graphite composite indicates that the ICP plays a significant role in the mechanism of conduction in these composite materials. When ICPs are dedoped, they become insulating. Therefore, if the ICP is playing a significant role in the conductivity of the composite, the conductivity should change dramatically when it is dedoped (in an alkali environment). As mentioned earlier, CB-PANi prior art composites did not demonstrate this dependence therefore, the strong pH dependency of GP conductivity was an unexpected and novel property of the present invention. Film resistivity studies were conducted on the composites synthesized with p-TSA as the dopant. FIG. 2 shows the results of the film studies of the GP films. The presence of the ICP appears to be the main factor in achieving low resistivities. The 70/30 composites gave lower resistivities than the 80/20 composites for all but three data points. This is especially significant because the 80/20 composites show higher bulk conductivities (GP-75 S/cm) than the 70/30 (GP-70 S/cm) composites. It is believed the greater amount of ICP homogenized in the graphite in the 70/30 composite was responsible for low resistivity values concomitant with low conductivity values. Thus, the greater amount of ICP resulted in the anomalous lower resistivity and lower conductivity values.

Table 1 shows the results of experiments performed by varying the dopants used in the synthesis of 80/20 GP composites. These results support the claim that the ICP aids in the high conductivity of the samples. The conductivities of the doped samples change as the dopant is varied. This can only be attributed to the conductivity of the ICP since the conductivity of graphite alone is not dependent upon acidic species. The dedoping of the samples reinforces this claim because the conductivity of the samples was lower for the dedoped composites as would be expected because the ICP becomes an insulator when treated with alkali solutions.

### EXAMPLE 4

An 80/20 GPPy composite was prepared by adding a 36.0 g of colloidal graphite (25% solids) and 25 mL of Dl water to a 125 mL nalgene bottle. A 2.07 mL aliquot of pyrrole was added and the solution was agitated for 3 hours. Then 18.634 g of FeCl₃.7H2O was added and the solution was diluted to the top of the bottle with Dl water and agitated overnight. The solution was filtered by vacuum through a Whatman #4 filter paper and washed with Dl water. The sample was dried under vacuum. The conductivity of the pressed pellet was determined to be 262 S/cm. The conductivity of the 80/20 GPPy composite was higher than the conductivity of the components. A 50/50 GPPy composite was also prepared and tested. The 50/50 composite had a conductivity of 2.467 S/cm. This low conductivity of the 50/50 composite is not yet understood as the conductivity of PPy is at least 20 S/cm, however, this information may be useful in further research.

### EXAMPLE 5

Synthesis of 80/20 GP from dry graphite using HMSA as dopant:

A 8.0 g sample of dry graphite was dispersed by agitation overnight in 24 mL water, 50.0 mL of 1M HMSA, and 2.00 mL aniline were added to a beaker. The solution was cooled to ˜0° C. Then 5.24 g g sodium persulfate was added. The reactions were allowed to stir overnight. The solution was then filtered by vacuum through a Whatman #4 filter paper and washed with distilled water. The cake was then washed twice with 50 mL1M HMSA. The sample was then dried under vacuum. The conductivity of the pressed pellet was 218 S/cm.

### EXAMPLE 6

Synthesis of 80/20 GP from dry graphite using HCl as dopant:

A 8.0 g sample of dry graphite was dispersed by agitation overnight in 24 mL water, 50.0 mL of 1M HCl, and 2.00 mL aniline were added to a beaker. The solution was cooled to ˜0° C. Then 5.24 g g sodium persulfate was added. The reactions were allowed to stir overnight. The solution was then filtered by vacuum through a Whatman #4 filter paper and washed with distilled water. The cake was then washed twice with 50 mL1M HCl. The sample was then dried under vacuum. The conductivity of the pressed pellet was 310 S/cm.

All publications, patents, and patent documents are incorporated by reference herein, as though individually incorporated by reference. Although the invention has been described with reference to a specific and preferred embodiment and technique, it should be appreciated by one of skill in the art that many variations and modifications may be made within the scope of this invention.

I claim:

1. A composite comprising a conductive carbon allotrope other than carbon black and an inherently conducting polymer.

2. The composite of claim 1 wherein said composite possesses a conductivity dependent upon pH.

3. The composite of claim 1 wherein said composite possesses a conductivity greater than the conductivity of the inherently conducting polymer.

4. The composite of claim 1 wherein said composite possesses a conductivity dependent upon an acid used to dope the composite.

5. A dispersible composite comprising graphite and doped polyaniline

6. A dispersible composite comprising graphite and doped polypyrrole.

7. A dispersible composite comprising graphite and doped polythiophene.

8. A dispersible composite comprising graphite and doped polyethylenedioxythiophene.

9. A dispersible composite comprising graphite and doped polyphenylenevinylene.

10. A composite comprising graphite and polyaniline, where the polyaniline is doped, and the dopant is selected from the group consisting of hydrochloric acid, methanesulfonic acid, p-toluenesulfonic acid o-phosphoric acid, sulfuric acid, (±)-10-camphorsulfonic acid (HCSA), 4,5-dihydroxy-2,7-naphthalenedisulfonic acid (4,5-DH-2,7-NSA), and 6,7-dihydroxy-2-naphthalenesulfonic acid (6,7-DH-2-NSA).

11. A composite comprising of graphite and polypyrrole, where the polypyrrole is doped, and the dopant is selected from the group consisting of hydrochloric acid, methanesulfonic acid, p-toluenesulfonic acid o-phosphoric acid, sulfuric acid, (±)-10-camphorsulfonic acid (HCSA), 4,5-dihydroxy-2,7-naphthalenedisulfonic acid (4,5-DH-2,7-NSA), and 6,7-dihydroxy-2-naphthalenesulfonic acid (6,7-DH-2-NSA).

12. A method of synthesizing doped graphite-polyaniline comprising oxidatively polymerizing aniline in the presence of dispersed graphite and an acid dopant.

13. The method of claim 12 wherein said polymerizing step is performed in the presence of water.

14. The method of claim 12 wherein the oxidant that is employed is selected from the group consisting of sodium persulfate, ferric chloride and hydrogen peroxide.

15. The method of claim 12 further comprising the step of dedoping the graphite-polyaniline by treating said doped graphite-polyaniline with an aqueous base.

16. The method of claim 15 wherein said aqueous base is aqueous sodium hydroxide or ammonium hydroxide.

17. A method of synthesizing doped graphite-polypyrrole comprising oxidatively polymerizing pyrrole in the presence of dispersed graphite.

18. The method of claim 17 wherein said polymerizing step is performed in the presence of water.

19. The method of claim 17 wherein the oxidant that is employed is selected from the group consisting of ferric chloride, sodium persulfate and copper nitrate.

20. The method of claim 17 further comprising the step of dedoping the graphite-polypyrrole by treating said doped graphite-polypyrrole with a reducing agent.

21. The method of claim 20 wherein said reducing agent is hydrazine.

22. A method of synthesizing doped graphite-polythiophene comprising oxidatively polymerizing thiophene in the presence of dispersed graphite.

23. The method of claim 22 wherein said polymerizing step is performed in the presence of water.

24. The method of claim 22 wherein the oxidant that is employed is selected from the group consisting of ferric chloride and ferric tosylate.

25. The method of claim 22 further comprising the step of dedoping the graphite-polythiophene by treating said doped graphite-polythiophene with a reducing agent.

26. The method of claim 25 wherein said reducing agent is hydrazine.

27. A method of synthesizing doped graphite-polyethylenedioxythiophene comprising oxidatively polymerizing ethylenedioxythiophene in the presence of dispersed graphite.

28. The method of claim 27 wherein said polymerizing step is performed in the presence of water.

29. The method of claim 27 wherein the oxidant that is employed is selected from the group consisting of ferric chloride and ferric tosylate.

30. The method of claim 27 further comprising the step of dedoping the graphite-polyethylenedioxythiophene by treating said doped graphite-polyethylenedioxythiophene with a reducing agent.

31. The method of claim 30 wherein said reducing agent is hydrazine.
